(19) United States
(12) Patent Application Publication
(10) Pub. No.: US 2003/0201666 A1
(43) Pub. Date: Oct. 30, 2003

(54) SPRAY SHIELD FOR AUTO WHEEL RIM

(75) Inventors: Andrew Artessa, Remsen, NY (US); Joseph Cattadoris, Utica, NY (US)

Correspondence Address: Bernhard P. Molldrem, Jr., 333 East Onondaga Street, Syracuse, NY, 13202, US

(73) Assignee: J & A Innovations, LLC

(21) Appl. No.: 10/302,703

(22) Filed: Nov. 25, 2002

Related U.S. Application Data
(60) Provisional application No. 60/376,696, filed on Apr. 30, 2002.

(51) Int. Cl. B60B 7/00

(52) U.S. Cl. 301/37.103

(57) ABSTRACT

A collapsible spray shield disk is combined with a gripping device. The spray shield disk member is a fabric web that is stretched onto a spring wire frame. The disk member normally has an expanded diameter large enough to cover and protect a vehicle wheel rim, but can be collapsed into a smaller diameter that is a fraction of that in the expanded configuration. A gripping device has an adjustable central gripper bar, and hinged end portions that clip onto diametrically opposed locations of the spring wire frame. The gripping device folds together to contain the spray shield when the latter is in its folded-down configuration. The disk member can employ a spray-resistant, film-coated fabric (e.g., vinyl, urethane, etc. on nylon) or a durable plastic film. The bar can be formed of interfitting slides so that its length can be adjusted.

### BACKGROUND OF THE INVENTION

This invention concerns a collapsible shield disk for protecting the wheel rim of an automobile from overspray and drips when a cleansing solution or other treatment is being applied to the automobile's tires.

A need exists for wheel shields and wheel protectors as an adjunct or aid in the cleaning of vehicle tires. Many motor vehicle owners are concerned about the appearance of their cars or trucks, and one aspect of the appearance is the tire. Many chemical compounds and mixtures are available that can be sprayed onto the rubber sidewalls of the vehicle tires, including compositions sold under the trademark ArmorAll. However, these compositions should not be applied onto metal surfaces, such as the metal rim or wheel on which the tire is mounted. For that reason, it is desirable to have a shield that can be held temporarily against the rim of the wheel when the cleaning composition is being applied to the tire. Several wheel and wheel cover spray shields have been proposed to protect the wheels from overspray of the cleaning or polishing materials. These shields tend to be rigid disks with a permanent handle affixed, e.g., as described in Sampson U.S. Pat. No. 4,874,206, or in Sherod et al. U.S. Pat. No. 5,423,599. In this case, the storage of the protective disks between uses is problematic, as they cannot be folded down or collapsed for storage between uses. One collapsible disk system has been proposed in U.S. Pat. No. 6,086,349, but in that case only a fabric handle is provided that is sewn onto the central part of the collapsible fabric disk. The disk is difficult to hold securely against the wheel because of the very flexibility of the handle and the material it is attached to. In addition, there is no simple means of holding the disk in its collapsed position for storage, and presumably some sort of separate container or some sort of band or strap would have to be provided.

### OBJECTS AND SUMMARY OF THE INVENTION

Accordingly, it is an object to provide a spray shield for assisting in the cleaning of tires mounted on a vehicle wheels, which is simple to use, which can be gripped and held easily in place against the wheel rim during use, and which can be easily collapsed and stored within its own fold-down gripper device.

It is a more specific object to provide a spray shield and a gripper device arrangement, in which the gripper includes mating slides that permit its length to be selected to match different diameters of spray shields, so as to accommodate different sizes of wheel rims.

If is a still further object to provide a spray shield and gripper arrangement that is not costly to manufacture and is inexpensive to purchase, and yet is simple and reliable in use.

According to one aspect of this invention, a collapsible spray shield is combined with a gripping device. The spray shield includes a disk member which has an expanded configuration in which its diameter is large enough to cover and protect a wheel of a vehicle from overspray. The spray shield also has a folded-down configuration in which it has a smaller diameter that is a fraction of that in the expanded configuration. The gripping device comprises a rigid member that attaches at diametrically opposed locations of a rim of the shield when the latter is in its expanded configuration, and includes at least one hinge member so that the gripping device folds together to contain the spray shield when the latter is in its folded-down configuration.

The collapsible shield disk is preferably made of a spray-resistant, film-coated fabric (e.g., vinyl, urethane, etc. on nylon) or a durable plastic film, that is stretched over a spring wire frame or rim. In combination with this is a foldable metal or plastic gripper that has end members that are hinged to a central grip bar. The shield disk can be folded down to a fraction of its full diameter for storage purposes, and the folded-down shield disk can be stored in the gripper, i.e., captured between the central bar portion and the two folded-in end members.

In an open position, the gripper end members fit over the spring rim to hold the disk. There can be slots or other openings provided into which the nm fits. This makes it possible for the user to hold the shield in place on the wheel rim with the outer part of the shield disk pressed against the wheel rim. The end members may be generally Y-shaped, and each holds the rim at two locations that are diametrically opposite the two locations on the rim where the other end member holds onto it.

The film or fabric material is preferably thermo-welded onto the spring frame or rim, but it may be sewn or cemented, if desired. Some suitable materials would include rip-stop nylon coated with urethane, 70-denier nylon taffeta, or vinyl coated nylon. There are many other suitable coated nylon fabrics or coated fabrics of synthetic or natural fibers.

The spring rim may be a band or ring of spring steel or stainless steel, or may be a special synthetic (e.g., spring plastic) material that could form a band or ring that is adapted to expand or collapse by twisting or folding to form a frame for the masking shield.

Preferably, the mask is a circular disk, but it is possible to make the shield as a semicircular half-disk, or kidney-shaped, or another shape if desired. Accordingly, the term “disk” and other similar terms as used here and in the claims should not be limited strictly to circular configurations.

The gripper component may be a suitable synthetic resin plastic, and may be injection molded, compression molded, or vacuum formed. Cycolac or another suitable plastic material may be used. The gripper parts may alternatively be stamped or extruded from aluminum or another metal. Plastic or metal pins or rivets may be used as pivots between the gripper bar and the end portions of the gripper.

The spring metal rim or frame may be adjustable in size or diameter, i.e., with ends clips that slide in or out to change its size. The gripper may have detentes to hold the end portions at one or more angles, e.g., to accommodate different size wheel rims.

The above and many other objects, features, and advantages of this invention will become apparent from the following discussion of a selected preferred embodiment, which should be read in conjunction with the accompanying Drawing.

### BRIEF DESCRIPTION OF THE DRAWING

FIG. 1 is an elevation view of an embodiment of a shield disk protector of this invention and a wheel rim of a car on which is mounted a tire which is to be applied a spray-on tire treatment.

FIG. 2 is an elevation view of the shield disk protector of this embodiment in place on the wheel rim.

FIG. 3 shows the collapsible shield disk of this invention.

FIG. 4 is a detail view taken at 4-4 of FIG. 3.

FIG. 5 is a view showing the shield disk of this embodiment being twisted into a more compact configuration and stowed into the accompanying gripper component.

FIG. 6 is a perspective view of the gripper component of this embodiment.

FIG. 7 is a side view thereof.

FIG. 8 shows detail of one end portion of the gripper component.

FIGS. 9A and 9B show the outer slide member of the central bar of the gripper.

FIGS. 10A and 10B show the inner slide member of the central bar of the gripper.

### DETAILED DESCRIPTION OF THE PREFERRED EMBODIMENT

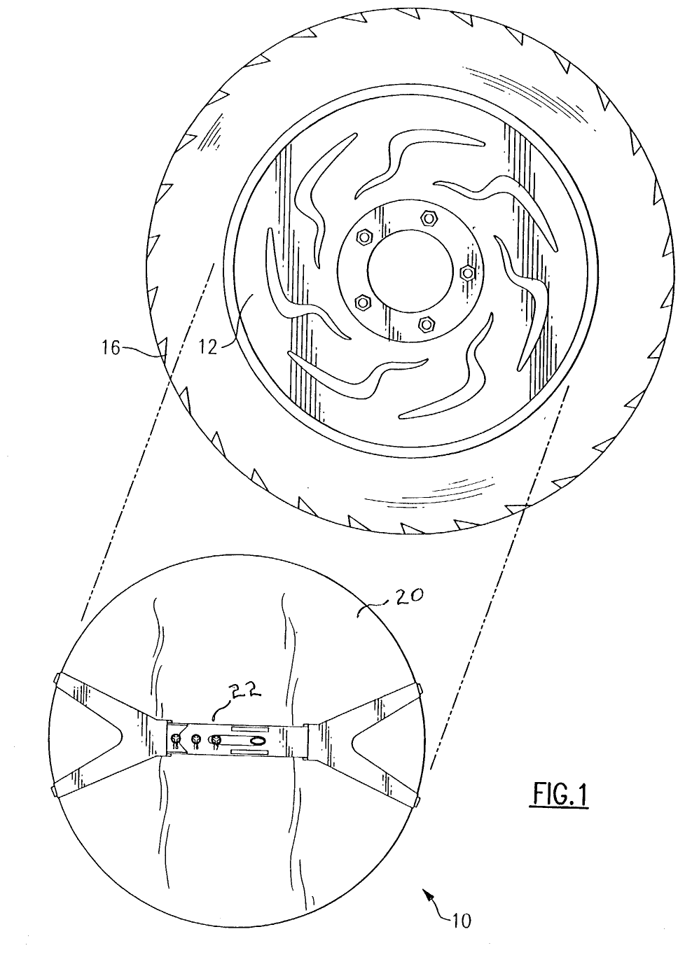

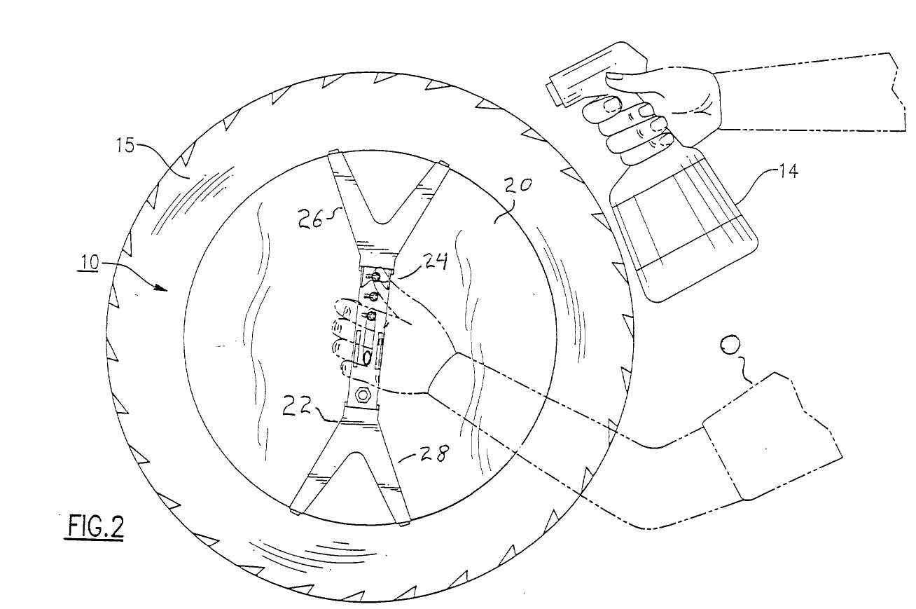

With reference to the Drawing, and initially to FIGS. 1 and 2, a car owner O (shown in ghost) uses the shield disk protector 10 of one embodiment to cover the wheel rim 12 of a car while he is applying a spray-on tire treatment 14 to the sidewall of a tire 16 that is mounted on the wheel rim 12. Here, the disk protector combines a collapsible fabric disk 20 and a gripper device 22 that has a central portion 24 that the car owner can grip with one hand, and a pair of end members 26 and 28 that are hinged to the ends of the central bar portion 24. The end members are generally forked or y-shaped, and the ends grip onto the rim of the disk 20. The bar 24 is adjustable to accommodate different size wheel rims, and in this embodiment the bar 24 comprises an outer slide portion 30 and an inner slide portion 32, with an adjustable detente 34 which is marked to accommodate 15-inch, 16-inch, and 17-inch wheel rims. The disk protector kit could come with three corresponding disks 20 of three different diameters, and the gripper device 22 can be adjusted in length to fit onto each one.

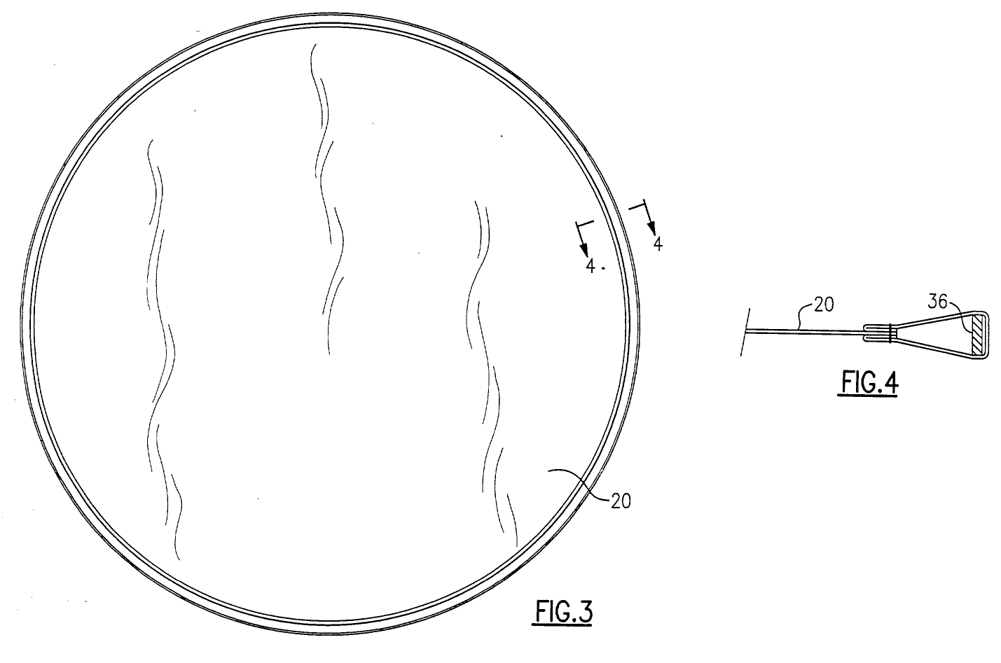

As shown in FIG. 3, the collapsible disk 20 can have a fabric web 34 of a suitable flexible material, i.e., fabric, which can be a synthetic fiber, woven or non-woven, or a film. In this embodiment, the fabric web 34 is a urethane-coated nylon, which resists the treatment material being used on the tire, and which can be wiped or rinsed clean before being put away. A flat spring wire (FIG. 4) is formed into a loop which constitutes the spring rim 36 of the disk 20. The urethane coating also allows the fabric to be heat welded or bonded over the spring rim. Alternatively, the material can be sewn or otherwise bonded over the spring rim 36.

FIG. 5 illustrates the manner in which the disk protector 10 of this embodiment can be folded down for storage. Here, with the gripper removed, the disk 20 is shown in its open, or expanded form (left). The car owner can simply grip this disk with both hands, and twist it as shown (second from left), so that it collapses into about a third to half the full, expanded disk diameter (second from right), and as such the gripper component 22 can be folded down over it to capture or contain it (right). Here the central bar 24 is on one side of the folded-down disk 20, and the end members 26, 28 are folded down onto the other side of the collapsed disk 20, so that the gripper sandwiched the disk 20, and the gripper component plus the collapsed disk can be stored in compact form on a shelf, or in a drawer or tool box.

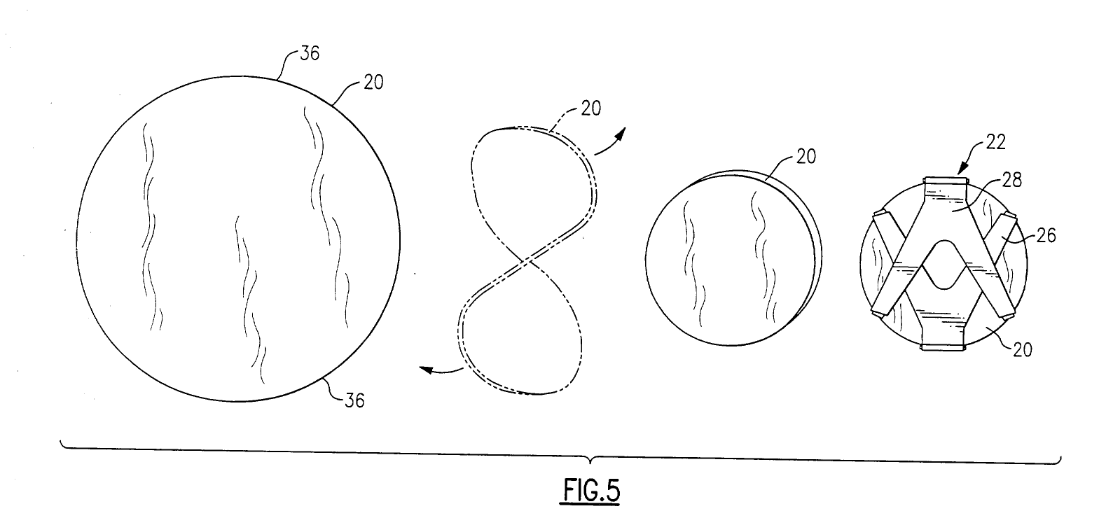

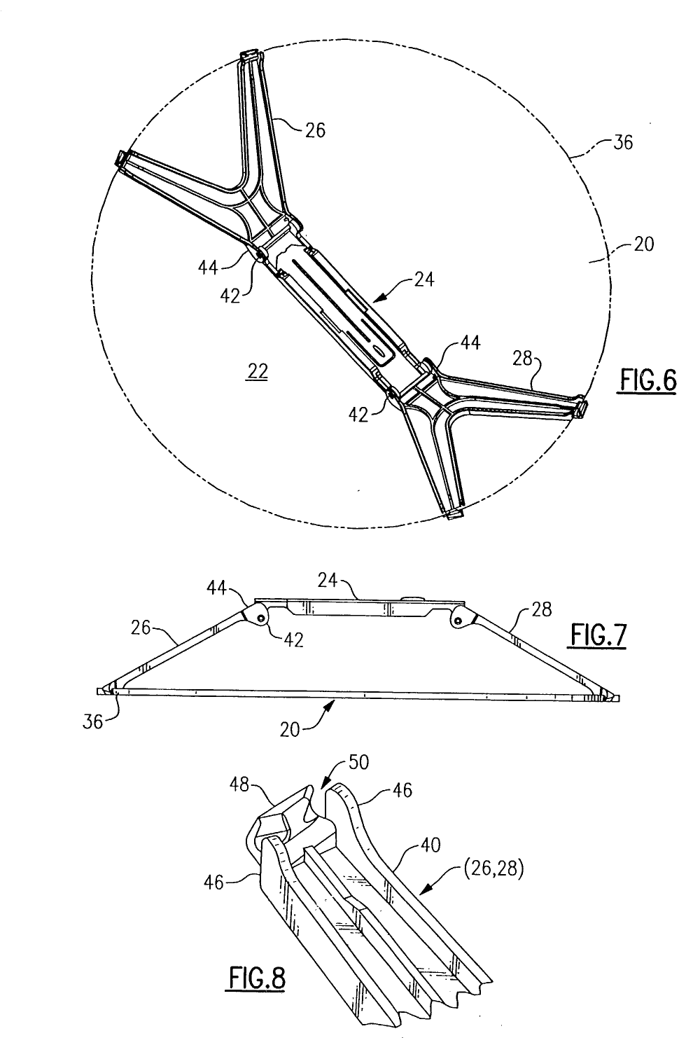

The gripper component 24 of this embodiment is shown in FIGS. 6 and 7 in its open position. Here, the forked or Y-shaped end members 26, 28 of the gripper are at an angle in respect to the central bar portion 24, so there is some space created between the gripper bar and the associated disk 20.

The folded-down handle and collapsed disk fit easily into the palm of the hand (FIGS. 3 and 4). In this configuration, the entire disk protector can fit into a drawer, automobile glove compartment, or a pocket. The disk protectors may be packaged in this configuration also for display and sale at an automotive store or other establishment.

FIG. 6 illustrates some of the features of the gripper device 22, and here shows individual legs 40 of each of the Y-shaped end members 26, 28. The ends of the legs 40 on the end members clip onto the spring rim 36 or spring frame, here shown in FIG. 6 with the fabric omitted for clarity of illustration. This view is seen from the back, or wheel-rim side. FIG. 7 is an elevation illustrating that a suitable amount of space exists from the disk 20 to the gripper bar 24. FIG. 7 also shows relevant proportions of the gripper elements. There are hinge pins or rivets 42 that pass through tabs or ears 44 at the proximal ends of the end members 26, 28 and through corresponding structure at the end of the central bar 24. Detail of the distal ends of the legs 40 of the end members 26, 28, is shown in FIG. 8. There are end tabs 46 at each side of the leg 40, and a generally trapezoidal protuberance 48, which between then define a slot 50 for the spring frame or rim 36. The shape of this structure 46, 48 creates a firm grip on the spring rim 36, i.e., to clip to it, but allows the disk 20 to be removed when the tire treatment operation is completed.

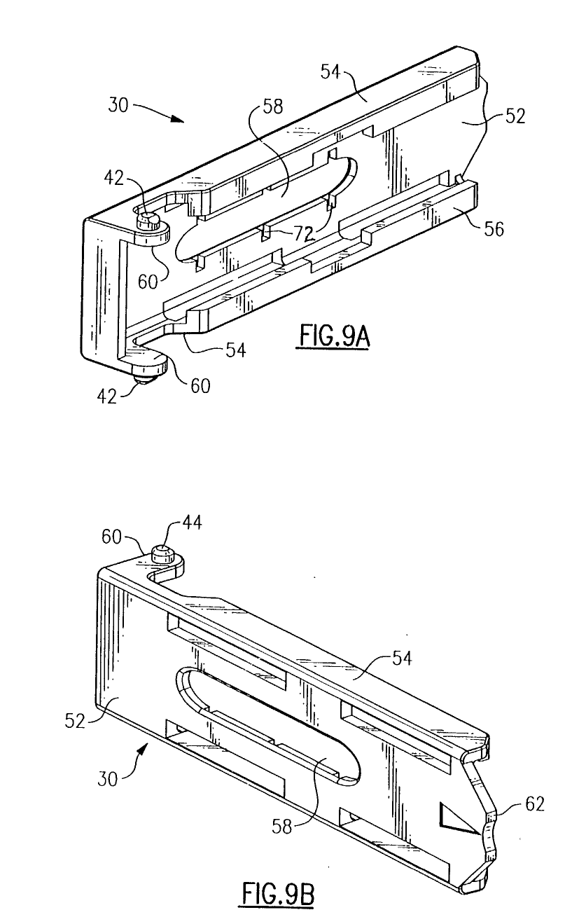

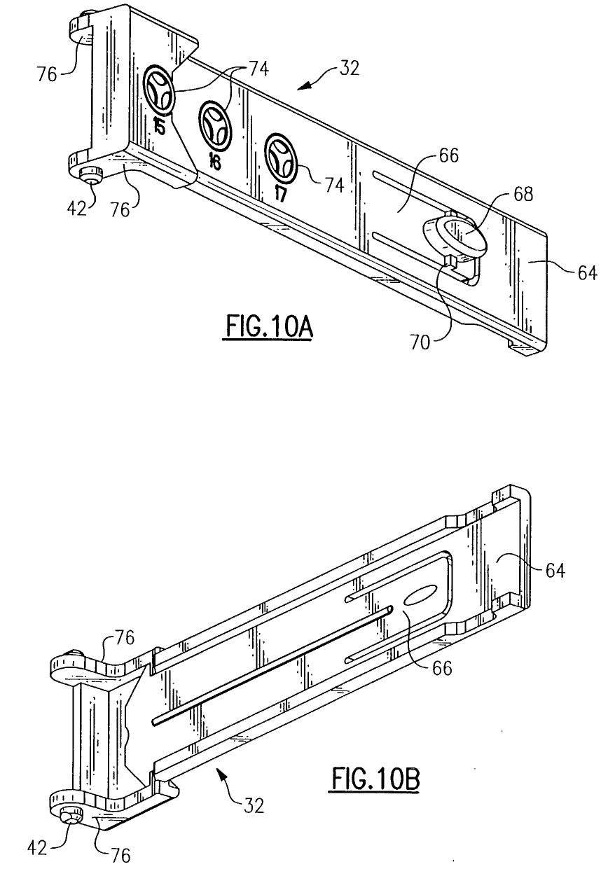

FIGS. 9A and 9B are perspective views of the outer slide portion 30 of the gripper central bar 24, with FIG. 9A showing the under side and FIG. 9B showing the upper side of the outer slide 30. The outer slide is formed as a channel member having an elongated web 52 with flanges 54 at its two long sides, and with a pair of rims 56 that are directed inwardly at the free edges of the flanges 54. There is an elongated opening 58 along the web. A pair of ears 60 are formed at the hinge end of the outer slide 30, and the hinge pins 42 are formed in these ears. The inner slide portion 32 is shown in FIGS. 10A and 10B, in which FIG. 10A shows the upper side of the inner slide and FIG. 10B shows the under side thereof. The slide 32 has an elongated web 64 which is dimensioned to fit slidably into the channel of the outer slide member 30. There is a spring tongue 66 formed in the web 64, with a push button 66 that projects upward from the tongue, and which has a pair of lateral ridges 70. The push button 66 is intended to project through the opening 58 in the outer slide 30, and the lateral ridges 70 lodge into transverse slots 72 that are positioned at spaced locations along the opening 58. The push button and spring tongue are employed for selectively changing the length of the central bar 24 to accommodate different size disks suited to a given wheel rim. Here, there are index numbers 74 formed on the upper surface of the web 64 of the inner slide, and the index 62 is positioned at a given one of these for each of the possible dimensions. In this embodiment, these index numbers 74 indicate a size suited for a fifteen-inch, sixteen-inch, or seventeen-inch wheel rim. As with the outer slide, the inner slide 32 has upstanding ears 76 on which the hinge pins 42 are formed. The user pushes the button 68 to deflect the tongue 66 and dislodge the ridges 70 from the slots 72, to free the slides 30, 32 for relative movement so the length of the bar 24 can be adjusted.

In the illustrated embodiment, the gripper component 22 may be injection molded, or alternatively it may be vacuum formed. The gripper may also be cast or stamped of metal.

In this embodiment, the spring rim or spring frame 36 is a unitary hoop of fixed size. However, in alternative embodiments, the spring rim may have sliding end clips to permit the diameter of the disk to be adjusted.

In other possible embodiments, rather than relying on a slide adjustment, the gripper component may have hinge portions with detentes so the handle can be set at any of a number of angles.

While the invention has been described in detail with respect to a preferred embodiment, it should be recognized that there are many alternative embodiments that would become apparent to persons of skill in the art. Many modifications and variations are possible which would not depart from the scope and spirit of this invention.

We claim:

1. In combination, a spring-rim fabric spray shield and a gripping device therefor, wherein the spray shield comprises a spring frame and a fabric shield that is assembled onto said spring frame; and wherein said gripping device includes a central bar, and end portions that are hingedly connected to the central bar, with means at distal ends of the end portions to clip onto the spring frame of the spray shield to permit a user hold the shield in place against the wheel rim of a vehicle.

2. The combination of claim 1, in which said fabric spray shield includes a fabric web coated with a plastic material.

3. The combination of claim 2, in which the fabric web is heat-welded onto said spring frame.

4. The combination of claim 1, in which said spray shield is collapsible into a fraction of its diameter, and said gripping device is adapted to fold down and contain the collapsed spray shield between said central bar and said end portions.

5. The combination of claim 1, in which the central bar of said gripping device includes first and second slide members which interfit and slide relative to one another, and selective locking means that permit the user to select a plurality of positions of the slide members relative to one another, so that the gripping device is adapted to fit onto the spring frames of spray shields of different diameters.

6. The combination of claim 5, in which the end portions of the gripping device are Y-shaped members.

7. The combination of claim 6, in which each said end portion defines a slot that clips onto said spring frame.

8. In combination, a collapsible spray shield and a gripping device therefore, wherein the spray shield includes a disk member which has an expanded configuration in which it has a diameter adapted to cover and protect a wheel of a vehicle from overspray; and which has a folded-down configuration in which it has a smaller diameter that is a fraction of that in the expanded configuration; and wherein said gripping device includes a rigid member that attaches at diametrically opposed locations of a rim of the shield when the latter is in its expanded configuration, and includes at least one hinge member so that the gripping device folds together to contain the spray shield when the latter is in its folded-down configuration.
